(19) United States
(12) Patent Application Publication
(10) Pub. No.: US 2008/0236910 A1
(43) Pub. Date: Oct. 2, 2008

(54) Low cost conversion of any internal combustion vehicle into hybrid electric vehicle

(76) Inventors: Joseph B. Kejha, Meadowbrook, PA (US); Sagar N. Venkateswaran, Glen Mills, PA (US)

Correspondence Address: JOSEPH B. KEJHA, 1022 Frederick Rd., MEADOWBROOK, PA, 19046, US

(21) Appl. No.: 11/731,826

(22) Filed: Mar. 31, 2007

(51) Int. Cl. B60K 6/00

(52) U.S. Cl. 180/65.2; 180/69.6; 903/905; 903/906

(57) ABSTRACT

This invention pertains to an economical method of easy conversion of any internal combustion fueled vehicle into a fuel saving hybrid electric vehicle (HEV) by an add-on kit, without replacing the engine and with a minimal modification of the vehicle body. The converted vehicle has a substantially longer driving range on the same amount of fuel than the vehicle before this conversion.

### CROSS REFERENCE TO RELATED DOCUMENTS

The subject matter of the invention is described in the Disclosure Document of Joseph B. Kejha et al., Ser. No. 574,195 filed on Mar. 31, 2005, and entitled “Low Cost Conversion of any Vehicle into Hybrid Electric Vehicle.”

### BACKGROUND OF THE INVENTION

1. Field of the Invention

This invention pertains to the method of easy conversions of internal combustion engine powered vehicles into hybrid electric vehicles, without replacing the engine and with a minimal modification of the engine and the vehicle body.

2. Description of the Prior Art

It is well known now, that hybrid electric vehicles extend the driving range of vehicles on the same amount of fuel (i.e. achieve more miles per gallon), as compared to conventional vehicles. With gasoline prices rising, there is a need to make fast as many hybrid electric vehicles as possible. However, it can not be easily done by making many new hybrids “from scratch”. A better solution to this problem, and it is the primary object of this invention, is to convert any existing vehicles into hybrid electric vehicles at relatively low cost and ease.

Prior art expensive method of conversion is to remove the existing drive system from the body of the vehicle and replacing it with a hybrid electric drive system having a smaller engine and electric motor. The electric motor is usually mounted on the crank shaft of the engine, or on the main drive shaft of the rear wheels' differential. This means virtually rebuilding the vehicle, which is impractical, time consuming and expensive. The lower cost and easier conversion method of this invention does not suffer from prior art problems and provides superior and efficient vehicles with extended driving range on the same amount of fuel, and has many other positive advantages.

### SUMMARY OF THE INVENTION

Now it has been found, that any internal combustion vehicle (ICV) can easily be converted at low cost into hybrid electric vehicle (HEV) by replacing at least one or all of its non-driven wheels with at least one or all new wheel(s) containing electric motor/generator(s) in one unit(s), and by adding at least one energy storage unit(s), such as capacitor(s), and/or ultracapacitor(s), and/or battery, preferably into the trunk, or a storage space of the vehicle, and connecting them by wires and/or cables through an electric/electronic control unit(s) with sensors.

The energy storage unit(s) may be located in any desirable and available place in the vehicle, but the trunk space behind the rear seats is preferred.

For example, a front wheel engine driven vehicle will have the electric motor/generator(s) in the rear wheels and the energy storage unit, such as a battery with an ultra-capacitor would be in the trunk above these electric wheels, which helps to compensate as a counter-weight against the “unsprung weight” of these wheel motors, resulting thus in a smoother ride. The axles and suspension supporting the new wheel(s) with-electric motor/generator(s) should be preferably reinforced or replaced with similar, stronger parts.

The control unit(s) communicate with the accelerator and brake pedals (or any other controls) of the vehicle, preferably without any additional operator's input, so that the operator can drive the vehicle preferably the same way as any other conventional vehicle before this conversion.

The purpose of the electric motor/generator(s) in the wheel(s) is to help the internal combustion engine during the acceleration from dead stop or standing, or during any acceleration during driving. This relieves the internal combustion engine torque and thus lowers the consumption of gasoline or any other fuel. When the vehicle reaches its cruising speed, or stops accelerating, the electric motors are disconnected and the vehicle continues to drive preferably only on the internal combustion engine. Any excess internal combustion cruising power can also drive the motor/generator(s) (connected through the road), which will recharge the electric energy storage unit(s). When the energy storage is full, it is disconnected from charge.

During braking, the purpose of the electric motor/generator is to assist the brakes and absorb partly or fully the energy of braking, and store the energy in the energy storage unit(s) to be ready for use for the next acceleration of the vehicle. Needless to say, that during braking, the electric motor(s) in the wheels become electric generator(s), since they have both functions and are driven by the inertia of the vehicle.

If two or more motor/generator(s) are used, then their controls should compensate for their different RPM during turns of the vehicle.

Since the existing large internal combustion engines are designed for acceleration power of the vehicles when maximum power is needed, and are oversized for cruising power, an additional fuel is saved by disabling (preferably permanently) at least one piston/cylinder's ignition and their fuel injection from functioning, because they are no longer needed for the acceleration, which is now assisted by electric wheel-motor(s) of this conversion.

This conversion should be custom designed to fit any vehicle as a kit or as an added-on option to new vehicles by their manufactures.

Additional advantages of this conversion are:
1. Four wheel (or more) drive in the snow and off-road.
2. Easy start of the engine in a cold weather, if low temperature operation ultracapacitors are used in the electric energy storage unit(s) and help the starting battery.

The principal object of this invention is to provide low cost and easy conversion method for converting any existing internal combustion vehicles into hybrid electric vehicles, which save fuel and extend the driving range.

Another object of this invention is to quickly reduce our dependence on the imported oil. Other objects and advantages of the invention will be apparent from the description and claims.

### BRIEF DESCRIPTION OF THE DRAWINGS

The nature and characteristic features of the invention will be more readily understood from the following description taken in connection with the accompanying drawing forming part hereof in which:

FIG. 1 is a diagrammatic, side elevational view of the front wheels drive vehicle, illustrating its components and preferred locations of the added electric drive components.

FIG. 2 is a diagrammatic,top elevational, sectional view of the vehicle at the line 2-2 of FIG. 1, illustrating location of its components, including the electric drive system.

FIG. 3 is a diagrammatic, side elevational view of the rear wheels drive vehicle, illustrating its components and preferred locations of the added electric drive components.

FIG. 4 is a diagrammatic, top elevational,sectional view of the vehicle at the line 4-4 of FIG. 3, illustrating location of its components, including the electric drive system.

Like numerals refer to like parts throughout the several views and figures. It should, of course, be understood that the description and the drawings herein are merely illustrative, and it will be apparent that various modifications, combinations and changes can be made of the structures and the systems disclosed without departing from the spirit of the invention and from the scope of the appended claims.

### DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

Fuel saving hybrid electric vehicles (HEV's) employ propulsion system comprising a smaller internal combustion engine than standard engine, in combination with an electric motor powered by a battery through a control unit with sensors, which usually requires designing and building the vehicles “from scratch”, or requires an extensive modification and rebuilding of the existing vehicles. Both methods are time consuming and expensive. The present invention employs a novel method of easy conversion of any internal combustion vehicle into hybrid electric vehicle, which is fast, simple and low cost, and thus it can accelerate our effort to be free from the imported oil.

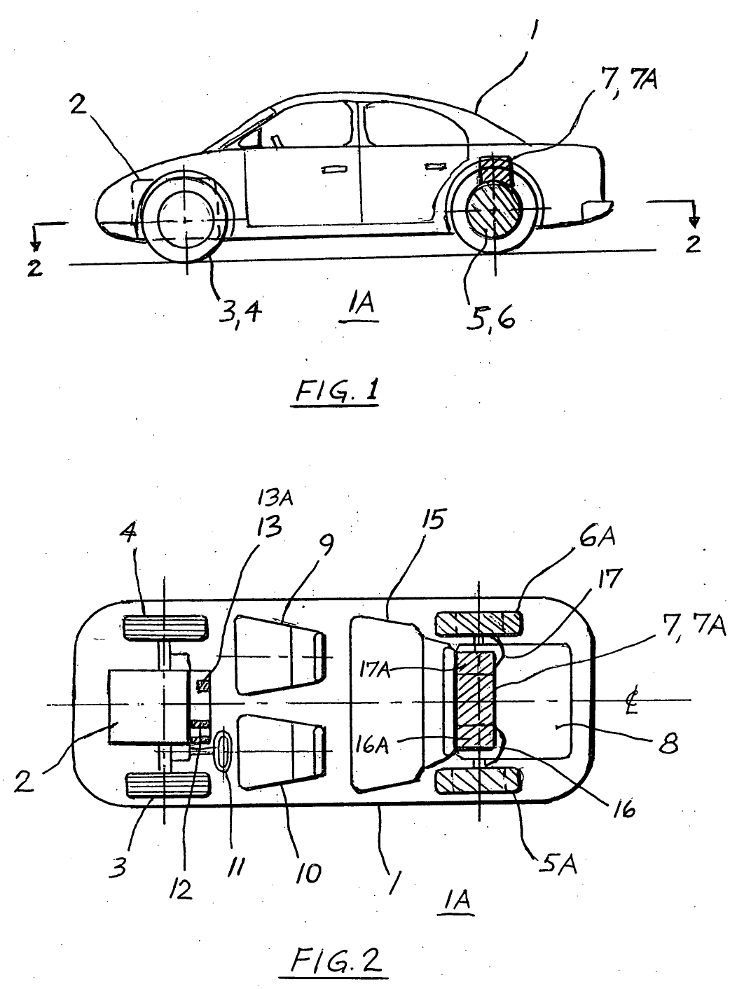

The invention will be better understood when referring in more detail to the drawings of this patent and FIGS. 1 and 2, which is one embodiment of this invention, illustrating as an example vehicle 1A, comprising body 1 with a large standard internal combustion engine 2 driving front wheels 3 and 4, which wheels are steered by steering system 11, and the vehicle includes passenger seats 9, 10 and 15 and trunk 8, and rear non-driven wheels 5A and 6A, which wheels are replaced with wheels having electric motor/generators in one unit(s) 5 and 6. Additionally, electric energy storage units 7 and 7A, are added into the trunk 8, and are connected with the electric motor/generators 5 and 6 via cables 16 and 17, through electric control units 16A and 17A. The units 16A and 17A are electrically connected to command potentiometer 12, attached to the gas pedal of the engine 2 by a well known link and lever (not shown), and the units 16A and 17A are also electrically connected to vehicle speed and acceleration sensors 13 and 13A. Only a small modification of the vehicle body by adding holes for the connecting cables and wires may be necessary. The energy storage unit(s) 7 and 7A may be located in any desirable and available place in the vehicle, but the trunk space behind the rear seats is preferred.

For example, a front wheels engine driven vehicle 1A will have the electric motor/generator(s) 5 and 6 in the rear wheels, and the energy storage unit, such as a battery 7 with an ultra-capacitor 7A are in the trunk above these electric wheels 5 and 6, which helps to compensate as a counter-weight against the “unsprung weight” of these wheel-motors, resulting thus in a smoother ride. The axles and suspension supporting the new wheel(s) with the electric motor/generator(s) should be preferably reinforced or replaced with similar, stronger parts.

The control unit(s) 16A and 17A communicate with the accelerator (or any other controls) of the vehicle, preferably without any additional operator's input, so that the operator can drive the vehicle preferably the same way as any other conventional vehicle before this conversion.

The purpose of the electric wheel-motor/generator(s) 5 and 6 is to help the internal combustion engine 2 during the acceleration from dead stop or standing, or during any acceleration during driving. This relieves the internal combustion engine torque and thus lowers the consumption of gasoline or any other fuel and extends the driving range. When the vehicle reaches its cruising speed, or stops accelerating as sensed by the sensors 13 and 13A, the electric wheel-motor 5 and 6 are disconnected by control units 16A and 17A and the vehicle 1A continues to drive preferably driven only by the internal combustion engine 2. Any excess internal combustion cruising power can also drive the motor/generator(s) 5 and 6 (connected through the road), which will recharge the electric energy storage unit(s) 7 and 7A. When the energy storage is full, it is disconnected form charge, through control unit(s) 16A and 17A. During braking, the purpose of the electric motor/generator(s) 5 and 6 is to assist the brakes and absorb partly or fully the energy of braking, and store the energy in the energy storage unit(s) 7 and 7A to be ready for use for the next acceleration of the vehicle. During braking, the electric motor(s) in the wheels become electric generator(s), since they have both functions and are driven by the inertia of the vehicle. Control units 16A and 17A also compensate for different RPM of the wheels 5 and 6 during turns of the vehicle, similarly as the differential gear box of the engine driven wheels. The control units may be also included in the wheel-motor/generator(s), instead being with the energy storage units. This provides for more trunk space.

Since the existing large internal combustion engines are designed for acceleration power of the vehicles when a maximum power is needed, and are oversized for cruising power, an additional fuel is saved by disabling (preferably permanently), in balanced manner at least one piston/cylinder's ignition and their fuel injection from functioning, because they are no longer needed for acceleration, which is now assisted by the electric wheel-motor(s). The non-working cylinders remain oiled. In combination with electric wheel-motor(s) and electric storage, this feature provides for a true hybrid electric vehicle without replacing the engine. These conversion components should be custom designed to fit any vehicle as a kit or as an added-on option to new vehicles by their manufacturers.

Additional advantages of this conversion are:
1. Four wheel (or more) drive in the snow and off-road.
2. Easy start of the engine in a cold weather, if low temperature operation ultra-capacitors are used in the electric energy storage unit(s) and help the starting battery.

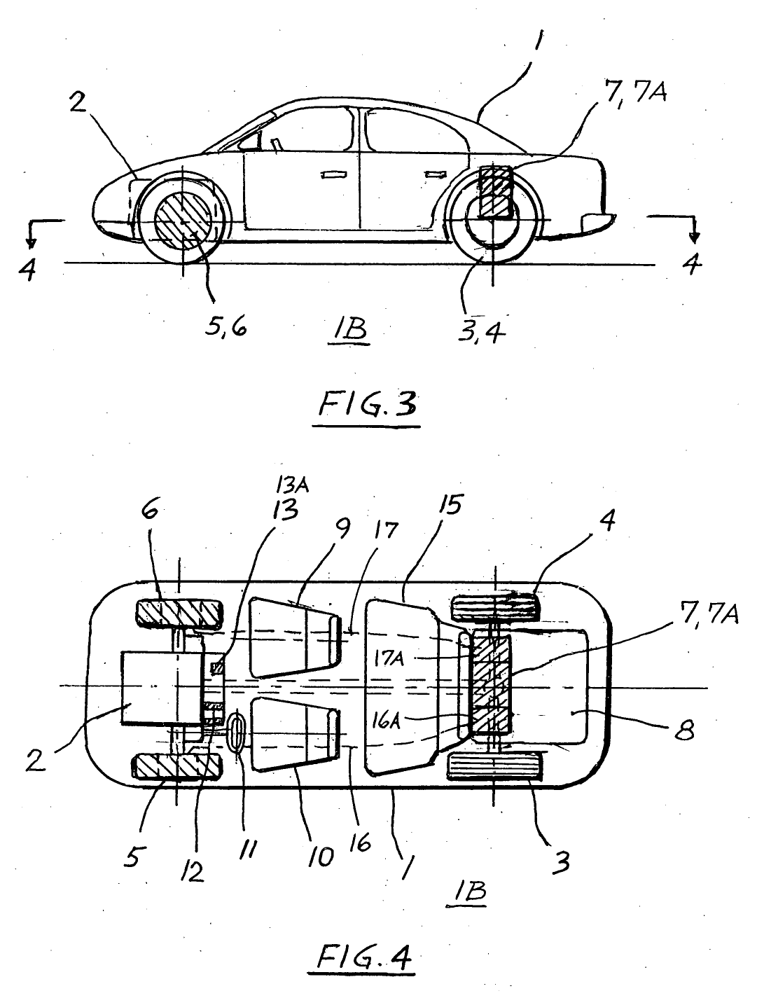

If a vehicle has its rear wheels driven by the engine, such as vehicle 1B shown in FIGS. 3 and 4, then the electric wheel-motor/generator(s) 5 and 6 may replace the front non-driven wheels. If a vehicle has four or more driven wheels, then at least one wheel should have its drive axel(s) disconnected and the wheel(s) replaced with the electric wheel-motor/generator(s) (not shown). Similarly, a three-wheeled vehicle's non-driven wheel(s) can be replaced with the electric wheel-motor/generator(s) (not shown).

It is apparent to any person skilled in the art that the described conversion method and kit can convert any internal combustion vehicle into a hybrid electric vehicle, and thus save fuel.

It should, of course, be understood that the description and the drawings herein are merely illustrative and it will be apparent that various modifications, combinations and changes can be made of the structures disclosed without departing from the spirit of the invention and from the scope of the appended claims.

It will thus be seen, that easy, economical and reliable conversion method of any internal combustion vehicle into hybrid electric vehicle (REV) has been provided with which the objects of the invention are achieved.

We claim:

1. A method of conversion of internal combustion vehicle into a fuel saving hybrid electric vehicle, comprising the steps of:
providing a steerable front wheel(s) driven internal fuel combustion vehicle, which vehicle includes a multi-piston engine with an ignition system and a fuel, a storage space, and non-driven rear wheel(s),
providing at least one electric wheel-motor/generator,
replacing said rear non-driven wheel(s) with said electric wheel-motor/generator(s),
providing at least one electric energy storage unit,
placing and mounting said electric energy storage unit(s) into said storage space,
providing at least one electric control unit for said electric wheel-motor/generator(s),
placing and mounting said electric control unit(s) into said storage space, electrically connecting said electric storage unit(s) with said electric control unit(s) via said electric control unit(s),
providing electric vehicle speed, engine torque, and acceleration sensors,
providing vehicle operator's electric command controls,
mounting said sensors and said command controls into said vehicle,
disconnecting said ignition system and said fuel, to at least one piston of said multi-piston engine,
and programming said electric control unit(s) to disconnect said electric motor(s) when a preset cruising vehicle speed and preset low engine torque is reached.

2. A method of conversion of internal combustion vehicle into a fuel saving hybrid electric vehicles, comprising the steps of:
providing a steerable, rear wheel(s) driven internal fuel combustion vehicle, which vehicle includes a multi-piston engine with an ignition system and a fuel, a storage space, and non-driven front wheel(s),
providing at least one electric wheel-motor/generator,
replacing said front non-driven wheel(s) with said electric wheel-motor/generator(s),
providing at least one electric energy storage unit,
placing and mounting said electric energy storage unit(s) into said storage space,
providing at least one electric control unit for said electric wheel-motor/generator(s),
placing and mounting said electric control unit(s) into said storage space, electrically connecting said electric storage unit(s) with said electric wheel-motor/generator(s) via said electric control unit(s),
providing electric vehicle speed, engine torque, and acceleration sensors,
providing vehicle operator's electric command controls,
mounting said sensors and said command controls into said vehicle,
disconnecting said ignition system, and said fuel to at least one piston of said multi-piston engine,
and programming said electric control unit(s) to disconnect said electric motor(s) when a preset cruising vehicle speed and preset low engine torque is reached.

3. A method of conversion of internal combustion vehicle into a fuel saving hybrid electric vehicle comprising the steps of:
providing a steerable all wheels driven internal fuel combustion vehicle, which vehicle includes a multi-piston engine with an ignition system and a fuel, and a storage space,
disconnecting said drive to at least one wheel,
providing at least one electric wheel-motor/generator,
replacing said drive disconnected wheel(s) with said electric wheel-motor/generator(s),
providing at least one electric energy storage unit,
placing and mounting said electric energy storage unit(s) into said storage space,
providing at least one electric control unit for said electric wheel-motor/generator(s),
placing and mounting said electric control unit(s) into said storage space, electrically connecting said electric storage unit(s) with said electric control unit(s) via said electric control unit(s),
providing electric vehicle speed, engine torque, and acceleration sensors,
providing vehicle operator's electric command controls,
mounting said sensors and said command controls into said vehicle,
disconnecting said ignition system, and said fuel to at least one piston of said multi-piston engine,
and programming said electric control unit(s) to disconnect said electric motor(s) when a preset cruising vehicle speed and preset low engine torque is reached.

4. A method of conversion of internal combustion vehicle into a fuel saving hybrid electric vehicle, as described in claim 1, or 2, or 3, in which said electric control units are included in said electric wheel-motor/generator(s).

5. A method of conversion of internal combustion vehicle into a fuel saving hybrid electric vehicle, as described in claim 1, or 2, or 3, in which said electric control units compensate for driving different revolutions per minute of said wheel-motor/generator(s) during turns of the vehicle.

6. A method of conversion of internal combustion vehicle into a fuel saving hybrid electric vehicle, as described in claim 1, or 2, or 3, in which said electric drive sensors and command controls communicate with said vehicles combustion engine controls and drive system sensors.

7. A method of conversion of internal combustion vehicle into a fuel saving hybrid electric vehicle, as described in claim 1, or 2, or 3, in which said electric energy storage unit comprise a battery and ultra-capacitor.

8. A method of conversion of internal combustion vehicle into a fuel saving hybrid electric vehicle, as described in claim 1, or 2, or 3, in which said electric energy storage unit is a battery.

9. A method of conversion of internal combustion vehicle into a fuel saving hybrid electric vehicle, as described in claim 1, or 2, or 3, in which said electric energy storage unit is an ultra-capacitor.

10. A method of conversion of internal combustion vehicle into a fuel saving hybrid electric vehicle, as described in claim 1, or 2, in which axle(s) and suspension of said electric wheel-motor/generator(s) is (are) reinforced.
